(19) United States
(12) Patent Application Publication
(10) Pub. No.: US 2025/0155303 A1
(43) Pub. Date: May 15, 2025

(54) PRESSURE SENSOR AND METHOD FOR MANUFACTURING THE SAME

(71) Applicant: Kistler Holding AG, Winterthur (CH)

(72) Inventors: Fabian von Bluecher, Steinach (CH); Marc Hehle, Konstanz (DE); Julian Hoefler, Hilzingen-Riedheim (DE); Sandro Brandenberger, Volken (CH)

(21) Appl. No.: 18/765,637

(22) Filed: Jul. 8, 2024

(30) Foreign Application Priority Data
Nov. 15, 2023 (EP) 23210128.7

(51) Int. Cl. G01L 7/16; G01L 19/14

(52) U.S. Cl. CPC G01L 7/163; G01L 19/14

(57) ABSTRACT

A pressure sensor includes a housing with an interior enclosing a plunger unit and a measuring element. The plunger unit includes a distal plunger end separated along a longitudinal axis from a proximal plunger end and further away from the measuring element than the proximal plunger end and protruding from the housing. The proximal plunger end transmits a pressure of a medium prevailing outside the housing to the measuring element. A sleeve is fastened to the housing spaced apart from the distal plunger end by a gap. A sealing element seals the gap to prevent the medium from entering the housing interior.

### FIELD OF THE INVENTION

The invention relates to a pressure sensor housing a plunger unit and a measuring element and to a method for manufacturing the same.

### BACKGROUND OF THE INVENTION

Pressure sensors are used in a wide variety of technical applications. The document WO2006/032152A1, which corresponds to applicant's commonly owned US Patent Application Publication No. 2007-277617, which is hereby incorporated in its entirety herein for all purposes, reveals a pressure sensor for measuring a pressure prevailing in a pressure chamber of an injection molding tool or an internal combustion engine. Said pressure sensor comprises a housing, a plunger and a measuring element. The housing comprises a housing interior in which housing interior the plunger and the measuring element are arranged. With regard to the measuring element, the plunger comprises a distal plunger end and a proximal plunger end. The proximal end of the plunger is in operative connection with the measuring element. The pressure sensor can be fastened in a bore in a wall of the pressure chamber via the housing. When the pressure sensor is fixed in the bore, the distal end of the plunger protrudes from the housing into the pressure chamber. The pressure to be measured is transferred from the distal end of the plunger to the proximal end of the plunger and acts on the measuring element.

The medium present in the pressure chamber is a liquid melt of plastic, metal, etc. in an injection mold or a fuel-air mixture in an internal combustion engine. The medium can exhibit a temperature of several hundred® C. and a pressure of several hundred bar. For a high sensitivity of the pressure sensor when measuring the pressure, the plunger is movably arranged with respect to the housing, which is realized by a gap between the housing and the plunger. In addition, in order to prevent the medium from entering the interior of the housing through the gap and damaging or destroying the measuring element there, the document WO2006/032152A1 teaches the arrangement of a metallic annular diaphragm in the gap, which annular diaphragm is attached to the plunger and to the housing by a welded joint and seals the gap.

However, the welded joint of the annular diaphragm represents a force shunt via which part of the pressure to be measured passes from the plunger into the housing, thus reducing the sensitivity of the pressure sensor when measuring the pressure. Particularly at high pressures of over 1000 bar, the annular diaphragm is arranged in a thick manner to ensure a long service life and then forms a noticeable force shunt. The annular diaphragm, which is welded to the housing and the plunger, also forms a vibrating system and is excited to vibrate during the pressure measurement, which vibrations can distort the pressure measurement. Finally, the location of the welded joint of the annular diaphragm in the gap between the housing and the plunger is difficult to reach with a welding tool, which makes the production of the welded joint complex and expensive.

### OBJECTS AND SUMMARY OF THE INVENTION

A first object of the present invention is to provide a pressure sensor which pressure sensor measures the pressure to be measured with high sensitivity and high accuracy. In particular, the pressure sensor should also be able to measure high pressures of over 1000 bar with high sensitivity and high accuracy. As a further object, a method for the simple and cost-effective manufacture of the pressure sensor is to be demonstrated.

At least one of the objects is solved by the features described hereinafter.

The invention relates to a pressure sensor with a housing, a plunger unit and a measuring element; which housing comprises a housing interior and which plunger unit and which measuring element are arranged in the housing interior; which plunger unit comprises a distal plunger end and a proximal plunger end, which distal plunger end is arranged on a longitudinal axis of the pressure sensor further away from the measuring element than the proximal plunger end, which distal plunger end protrudes from the housing and which proximal plunger end is in operative connection with the measuring element and transmits a pressure of a medium prevailing outside the housing to the measuring element; wherein the pressure sensor comprises a sleeve, which sleeve is attached to the housing; wherein the sleeve and the distal plunger end are spaced apart from one another by a gap; and wherein the pressure sensor comprises at least one sealing element, which sealing element seals the gap for the medium to the interior of the housing by sealing pressure.

The present invention also relates to a method for manufacturing a pressure sensor, comprising a housing, a plunger unit and a measuring element; which housing comprises a housing interior and which plunger unit and which measuring element are arranged in the housing interior; which plunger unit comprises a distal plunger end and a proximal plunger end, which distal plunger end is arranged on a longitudinal axis of the pressure sensor further away from the measuring element than the proximal plunger end and which distal plunger end protrudes from the housing and which proximal plunger end is in operative connection with the measuring element and transmits a pressure of a medium prevailing outside the housing to the measuring element; wherein in a first step of the method the housing and a sensor unit with a plunger unit and a measuring element are provided, and that the housing is pushed along the longitudinal axis over the plunger unit and placed on the sensor unit; wherein in a second step of the method at least one sealing element is provided, and that the sealing element is pushed along the longitudinal axis over the distal plunger end and placed on the housing; and wherein in a third step of the method a sleeve is provided and pushed along the longitudinal axis over the distal plunger end and placed on the sealing element and the housing, which sleeve and which distal plunger end are spaced apart from each other by a gap, and which sealing element seals the gap for the medium to the housing interior by sealing pressure.

In contrast to the teaching of the document WO2006/032152A1, the present invention avoids a force shunt for sealing the gap between the plunger and the housing. Said gap is sealed by means of sealing pressure, whereby the pressure to be measured is largely completely transferred from the plunger to the measuring element and a high sensitivity and high accuracy are achieved when measuring the pressure.

Advantageous developments of the object of the present invention are provided throughout the detailed description.

In an advantageous development, the sealing element is toroidal in shape and consists of elastically sealing material such as elastomer, in particular of fluoroelastomer or of perfluoroelastomer, or of rubber, in particular of acrylonitrile-butadiene rubber.

In further contrast to the teaching of the document WO2006/032152A1, the sealing element made of elastic material does not represent a vibrating system which can be excited to vibrate during pressure measurement, which vibrations can falsify the measurement of the pressure. Avoiding such vibrations enables the pressure to be measured with high sensitivity and high accuracy.

In a further advantageous development, a groove is formed radially on the inside of the sleeve and on the housing in the third step of the method by placing the sleeve on the housing around the sealing element with respect to the longitudinal axis.

Such a production of a groove for accommodating the sealing element is simple and inexpensive.

In a further advantageous development, the groove comprises several groove walls; wherein the groove walls exert a pre-compression on the sealing element arranged in the groove; and wherein the pressure in the gap acts on the sealing element as a compression in addition to the pre-compression, which pre-compression and which compression form the sealing pressure.

The two-stage sealing by a pre-compression and a compression ensures that even at low pressure, no medium can enter the interior of the housing through the gap and damage or destroy the measuring element at this place. The production of the groove pre-loading the sealing element is simple and inexpensive.

In a further advantageous development, the groove is rectangular or triangular or trapezoidal or round or semicircular in cross-section.

These different cross-sectional geometries allow the magnitude of the pre-compression exerted by the groove walls on the torus-shaped sealing element to be adjusted. For a sealing element with given dimensions, a higher pre-compression is achieved with groove walls that are inclined with respect to the longitudinal axis or with round groove walls that are curved into the sleeve or housing with respect to the longitudinal axis compared to groove walls that are straight with respect to the longitudinal axis. This means that the pressure sensor can also be operated at high pressures of over 1000 bar without medium entering the interior of the housing through the gap. Manufacturing the different geometries of the groove is simple and cost-effective.

In yet another advantageous development, the plunger unit comprises a pre-load sleeve and a pre-load body; wherein the proximal plunger end merges into the pre-load sleeve; wherein the pre-load sleeve encloses a pre-load sleeve chamber, in which pre-load sleeve chamber the measuring element is arranged; wherein an end of the pre-load sleeve facing away from the proximal plunger end is fastened to the pre-load body via a material-locking pre-load sleeve-pre-load body connection; and wherein the measuring element is arranged on the longitudinal axis between the proximal plunger end and the pre-load body under mechanical pre-load.

This development prevents mechanical stresses, which originate from the attachment of the pressure sensor in the wall of the pressure chamber, from reaching the measuring element from the housing and distorting the measurement of the pressure. Preventing the transmission of such mechanical stresses increases the sensitivity and accuracy of the pressure measurement.

### BRIEF DESCRIPTION OF THE DRAWINGS

In the following, the invention is explained in more detail by way of example with reference to several embodiments with reference to the figures, in which:

FIG. 1 is a cross-section through a part of a pressure sensor 1 according to the present invention, comprising a sensor unit 10, a housing 20, a sleeve 30 and a sealing element 40 in a rectangular groove 50;

FIG. 2 is a cross-section through a part of a pressure sensor 1 according to the present invention, comprising a sensor unit 10, a housing 20, a sleeve 30 and a sealing element 40 in a triangular groove 50;

FIG. 3 is a cross-section through a part of a pressure sensor 1 according to the present invention, comprising a sensor unit 10, a housing 20, a sleeve 30 and a sealing element 40 in a trapezoidal groove 50;

FIG. 4 is a cross-section through a part of a pressure sensor 1 according to the present invention, comprising a sensor unit 10, a housing 20, a sleeve 30 and a sealing element 40 in a round groove 50;

FIG. 5 is a cross-section through a part of a pressure sensor 1 according to the present invention, comprising a sensor unit 10, a housing 20, a sleeve 30 and a sealing element 40 in a semicircular groove 50;

FIG. 6 is a cross-section through a part of a pressure sensor 1 according to the present invention, comprising a sensor unit 10, a housing 20, a sleeve 30 and a sealing element 40 in a semicircular groove 50; and

FIG. 7 is a cross-section through the sensor unit 10 of the pressure sensor 1 according to the present invention as shown in FIGS. 1 to 6;

FIG. 8 is an exploded view of a part of the components of the pressure sensor 1 according to the present invention as shown in FIGS. 1 to 6, comprising the sensor unit 10, the housing 20, the sleeve 30 and the sealing element 40; and

FIG. 9 is a view of a first step of the method of manufacturing the pressure sensor 1 according to the present invention as shown in FIGS. 1 to 6, where the housing 20 is placed on the sensor unit 10;

FIG. 10 is a view of a second step of the method of manufacturing the pressure sensor 1 according to the present invention as shown in FIG. 9, where the sealing element 40 is placed on the housing 20; and

FIG. 11 is a view of a third step of the method of manufacturing the pressure sensor 1 according to the present invention as shown in FIG. 10, where the sleeve 30 is placed on the sealing element 40 and the housing 20.

In the figures, identical reference numerals denote identical objects.

### DETAILED DESCRIPTION OF EXEMPLARY EMBODIMENTS OF THE INVENTION

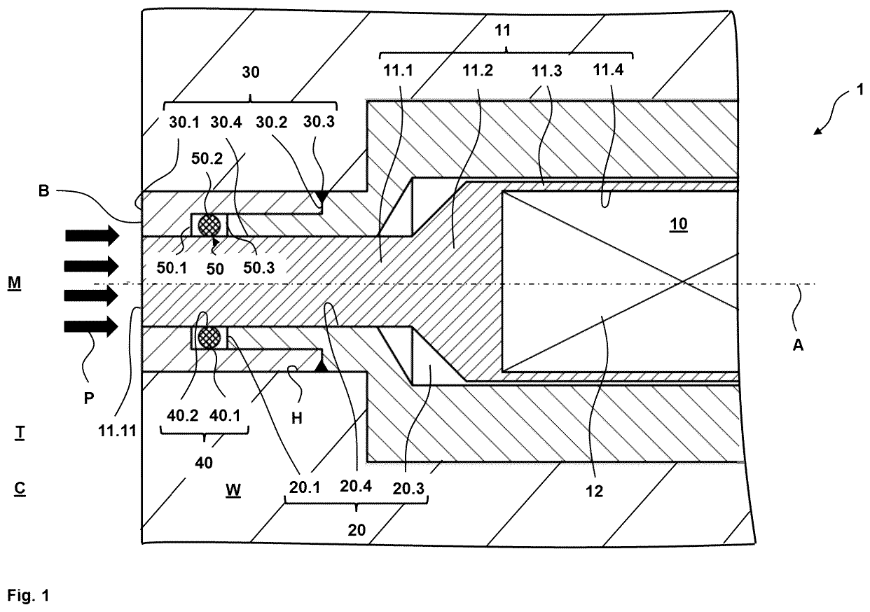

FIGS. 1 to 6 show cross-sections through several embodiments of a part of a pressure sensor 1 according to the present invention. The pressure sensor 1 has the function of measuring the pressure P of a medium M in a pressure chamber C. The pressure chamber C can be located in an injection mold, in an internal combustion engine, etc. In an injection mold, the medium M is a liquid melt of plastic, metal, etc. In an internal combustion engine, the medium M is a fuel-air mixture. The medium M can have a temperature T of several hundred® C. and a pressure P of several thousand bar. Preferably, the temperature T is in the range from 100° C. to 500° C. and the pressure P is in the range from 50 bar to 5000 bar. The pressure P to be measured is schematically shown as black arrows in FIGS. 1 to 6.

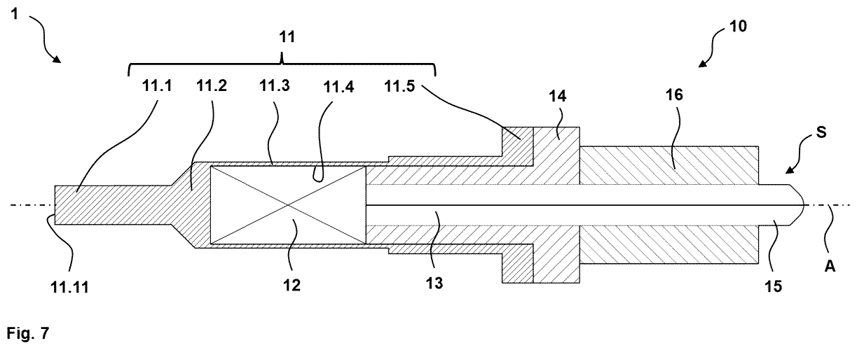

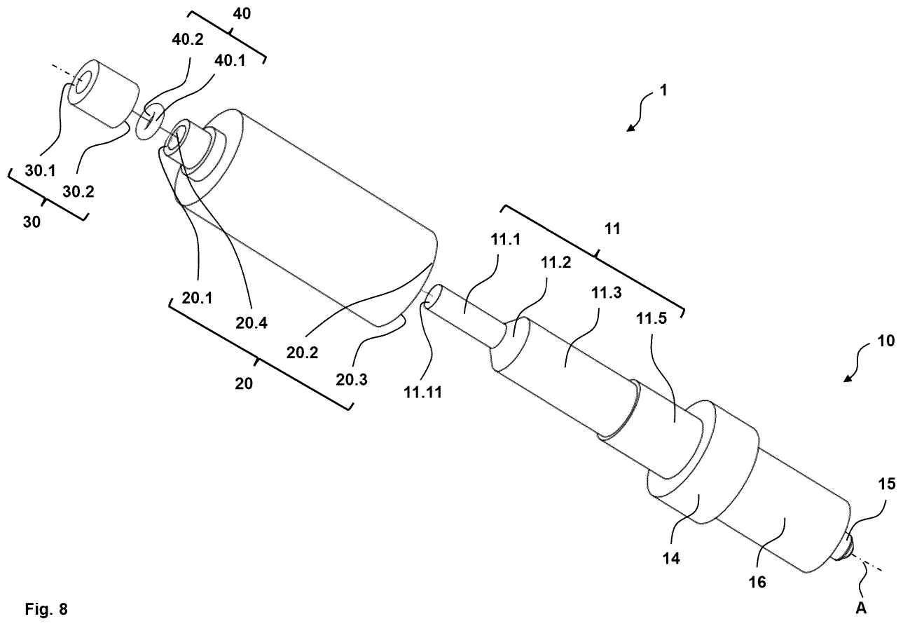

The pressure sensor 1 comprises a sensor unit 10. The sensor unit 10 has the function of accommodating a measuring element 12. The sensor unit 10 is only partially shown in FIGS. 1 to 6, but the sensor unit 10 is shown entirely in the cross-section of FIG. 7 and in the exploded view of FIG. 8.

The pressure sensor 1 exhibits a longitudinal axis A. FIGS. 1 to 8 show the pressure sensor 1 along the longitudinal axis A.

The pressure sensor 1 comprises a housing 20. The housing 20 has the function of fastening the sensor unit 10 in a bore H of a wall W of the pressure chamber C. The fastening of the pressure sensor 1 via the housing 20 in the bore H can be a screw connection. The screw connection is not shown in the figures.

In the embodiments shown in the figures, the housing 20 is hollow cylindrical and consists of mechanically resistant material such as pure metals, nickel alloys, cobalt alloys, iron alloys, etc. As can be clearly seen in FIG. 8, the housing 20 comprises a distal housing end 20.1 and a proximal housing end 20.2, which distal housing end 20.1 is arranged on the longitudinal axis A further away from the measuring element 12 than the proximal housing end 20.2. As schematically shown in FIGS. 1-6, the housing 20 defines a housing interior 20.3. With respect to the longitudinal axis A, the housing 20 radially encloses the housing interior 20.3. The sensor unit 10 is arranged in the housing interior 20.3.

In addition to the measuring element 12, the sensor unit 10 comprises a plunger unit 11 schematically shown in FIG. 8 for example.

The plunger unit 11 is configured to perform the first function of receiving and thus detecting the pressure P to be measured and transmitting the measured pressure to the measuring element 12. For this purpose, as schematically shown in FIG. 8 for example, the plunger unit 11 has a distal plunger end 11.1, a proximal plunger end 11.2 and a pre-load sleeve 11.3. The plunger unit 11 is made of mechanically resistant material such as pure metals, nickel alloys, cobalt alloys, iron alloys, etc. In the embodiments shown in the figures, the distal plunger end 11.1, the proximal plunger end 11.2 and the pre-load sleeve 11.3 are formed in an integral manner as a unitary structure. The distal plunger end 11.1 and the proximal plunger end 11.2 desirably are cylindrical in their shapes and merge into one another. The proximal plunger end 11.2 desirably defines a transitional portion that merges into the pre-load sleeve 11.3. As schematically shown in FIG. 7 for example, the pre-load sleeve 11.3 is hollow and cylindrical in its interior and encloses a pre-load sleeve chamber 11.4. The measuring element 12 is arranged in the pre-load sleeve chamber 11.4. The distal plunger end 11.1 is arranged to elongate on the longitudinal axis A further away from the measuring element 12 than the proximal plunger end 11.2. The distal plunger end 11.1 has an end face at its end, which is also referred to as the pressure absorption surface 11.11. The pressure P to be measured acts on the distal plunger end 11.1 via the pressure absorption surface 11.11 and is transmitted from the distal plunger end 11.1 to the proximal plunger end 11.2. As schematically shown in FIGS. 1-6 for example, the pressure P to be measured then acts directly on the measuring element 12 from the proximal plunger end 11.2.

The plunger unit 11 desirably is configured to perform the further function of preventing mechanical stresses, which originate from the attachment of said pressure sensor 1 in the bore H of the wall W of the pressure chamber C, from reaching the measuring element 12 from the housing 20, because such mechanical stresses can falsify the measurement of the pressure P. For this purpose, as schematically shown in FIGS. 7 and 8, the plunger unit 11 has a pre-load body 11.5. In the embodiment shown in the figures, the pre-load body 11.5 is hollow cylindrical. One end of the pre-load sleeve 11.3 facing away from the proximal plunger end 11.2 is attached to the pre-load body 11.5. Due to the attachment, the measuring element 12 is configured and arranged symmetrically with respect to the longitudinal axis A between the proximal plunger end 11.2 and the pre-load body 11.5 under mechanical pre-load. The term “mechanical pre-load” means that the mechanical pre-load is formed before the actual measurement of said pressure P. Preferably, an amount of the mechanical pre-load is greater by at least one decimal order of magnitude than possible mechanical stresses from the attachment of the pressure sensor 1 via the housing 20 in the wall W of the pressure chamber C.

The pre-load sleeve 11.3 is thin-walled having a wall thickness of 0.1 mm or less measured in a direction that is normal to the longitudinal axis A. The thin-walled pre-load sleeve 11.3 enables a high degree of mobility of the plunger 11 and thus a high sensitivity of the pressure sensor 1. Penetration of medium M with high temperature T and high pressure P through the gap 30.4 schematically shown in FIGS. 1-6 and into the housing interior 20.3 has to be prevented. In the case of an injection mold, the medium M is a liquid melt, which liquid melt would harden in the housing interior 20.3 and would thus prevent the plunger 11 from moving. In an internal combustion engine, the medium M is a fuel-air mixture, which fuel-air mixture is chemically aggressive and would corrode the pre-load sleeve 11.3 in the housing interior 20.3 and thus damage or destroy it.

The measuring element 12 has the function of generating a measuring signal S for the pressure P to be measured. The measuring element 12 can be a piezoelectric measuring element, a piezoresistive measuring element, a strain gauge, etc. A variable of the measurement signal S is proportional to the measured pressure P.

As schematically shown in FIG. 7 for example, the sensor unit 10 also comprises an electrode arrangement 13, a socket unit 14, a socket contact 15 and an insulating body 16.

Said socket unit 14 is configured to perform the function of accommodating the electrode arrangement 13, the socket contact 15 and the insulating body 16. For this purpose, the socket unit 14 is configured to define a hollow cylindrical socket housing made of mechanically resistant material such as pure metals, nickel alloys, cobalt alloys, iron alloys, etc. The socket housing is attached to the pre-load body 11.5 via a socket housing pre-load body connection on the side of the pre-load body 11.5 facing away from the measuring element 12. Within the socket housing, the socket unit 14 is configured to define a socket chamber. The electrode arrangement 13, the socket contact 15 and the insulating body 16 are arranged in the socket chamber.

The electrode arrangement 13 is configured to perform the function of conducting the measuring signal S from the measuring element 12 to the socket contact 15. In the embodiment of the sensor unit 10 shown in the figures, the electrode arrangement 13 is defined generally by a cylindrical shape and consists of electrically conductive material such as copper, silver, gold, etc. The electrode arrangement 13 is arranged at the end of the socket unit 14 facing the measuring element 12 and extends from the socket chamber into the pre-load sleeve chamber 11.4. The electrode arrangement 13 is electrically connected to the measuring element 12. The electrode arrangement 1 transmits the measurement signal S from the measuring element 12 along the longitudinal axis A to the socket contact 15.

Said socket contact 15 is configured to perform the function of making the measurement signal S available outside the socket unit 14. In the embodiment shown in the figures, the socket contact 15 is defined generally by a cylindrical shape and is made of electrically conductive material such as copper, silver, gold, etc. The socket contact 15 is arranged at the end of the socket unit 14 facing away from the measuring element 12. The electrode arrangement 13 and the socket contact 15 are electrically connected to each other.

The insulation body 16 is configured to perform the function of electrically insulating the electrode arrangement 13 and the socket contact 15 from the socket housing. The insulating body 16 is hollow and defined generally by a cylindrical shape and is made of electrically insulating and mechanically rigid material such as ceramic, Al₂O₃ ceramic, sapphire, etc. With respect to the longitudinal axis A, the insulating body 16 is arranged radially outside the electrode arrangement 13 and the socket contact 15 as schematically shown in FIGS. 7 and 8 for example.

Thus, the plunger unit 11 and the measuring element 12 are arranged as part of the sensor unit 10 in the housing interior 20.3. The distal plunger end 11.1 protrudes from the housing 20. According to FIG. 1, the distal housing end 20.1 defines a housing opening 20.4. The distal plunger end 11.1 protrudes through the housing opening 20.4 up to the pressure chamber C to be exposed to the influence of the pressure P.

According to the present invention, the pressure sensor 1 comprises a sleeve 30. The sleeve 30 is configured to perform the function of accommodating at least one sealing element 40. Said sleeve 30 is hollow and defined generally by a cylindrical shape and is made of mechanically resistant material such as pure metals, nickel alloys, cobalt alloys, iron alloys, etc. In the embodiments shown in the figures, the sleeve 30 defines a distal sleeve end 30.1 and a proximal sleeve end 30.2, which distal sleeve end 30.1 is arranged along the longitudinal axis A further away from the measuring element 12 than the proximal sleeve end 30.2.

Preferably, the distal plunger end 11.1 extends to the distal sleeve end 30.1. The pressure absorption surface 11.11 and the distal sleeve end 30.1 lie in a pressure absorption level B perpendicular to the longitudinal axis A as schematically shown in FIGS. 1-6. This has the advantage that the pressure P can only act on the distal plunger end 11.1 parallel to the longitudinal axis A via said pressure absorption surface 11.11. This prevents a pressure component that is not parallel to the longitudinal axis A from acting on the distal plunger end 11.1, which can falsify the measurement of the pressure P if the measuring element 12 generates interference signals for such a pressure component that is not parallel to the longitudinal axis A. Avoiding such a pressure component acting non-parallel to the longitudinal axis A increases the sensitivity and accuracy of the measurement of the pressure P. Alternatively, this has the advantage that the distal plunger end 11.1 and the distal sleeve end 30.1 can be specifically adapted to the surface geometry of the wall W of the pressure chamber C by cutting them to length. The distal plunger end 11.1 and the distal sleeve end 30.1 can thus be cut to length to a surface geometry of the wall W of the pressure chamber C that is inclined or curved with respect to the longitudinal axis A.

The sleeve 30 is attached to the housing 20. Preferably, the sleeve 30 is attached at the proximal sleeve end 30.2 to the distal housing end 20.1 via a sleeve-housing connection 30.3. With respect to the longitudinal axis A, said sleeve-housing connection 30.3 is arranged radially on the outside at the proximal sleeve end 30.2 and at the distal housing end 20.1. The sleeve-housing connection 30.3 is made by welding, soldering, screwing, pressing, gluing, etc. In the embodiments shown in the figures, the sleeve-housing connection 30.3 is a welded connection.

Said sleeve 30 surrounds the distal plunger end 11.1 in certain regions thereof. With respect to the longitudinal axis A, the sleeve 30 encloses the distal plunger end 11.1 radially on the outside thereof. The distal plunger end 11.1 exhibits a lateral surface. Preferably, the sleeve 30 completely surrounds the lateral surface of the distal plunger end 11.1 radially on the outside at an angle of 360°.

The sleeve 30 and the distal plunger end 11.1 are spaced apart by a gap 30.4. Preferably, the gap 30.4 exhibits a width of less than or equal to 0.1 mm in the radial direction perpendicular to the longitudinal axis A.

Said sleeve 30 and housing 20 form at least one groove 50 as schematically shown in FIGS. 1-6. The groove 50 serves to accommodate the sealing element 40. Preferably, the groove 50 is arranged in the region of the proximal sleeve end 30.2 and the distal housing end 20.1. The sealing element 40 is arranged in the groove 50.

The sleeve 30 desirably can be configured to have a length of several cm along the longitudinal axis A. The groove 50 and the sealing element 40 are then located at a relatively large distance of several cm from the pressure chamber C. This has the advantage that, in the case of a medium M with a high temperature T, the sealing element 40 is not exposed to the high temperature T of the medium M during operation of the pressure sensor 1, since the temperature T in the wall W and thus also in the sleeve 30 decreases as the distance from the pressure chamber C increases.

Along the longitudinal axis A, however, the sleeve 30 can also have a length of only a few millimeters. The groove 50 and the sealing element 40 are then located at a relatively short distance of a few millimeters from the pressure chamber C. This has the advantage that a medium M having a low viscosity cannot penetrate far into the gap 30.4 along the longitudinal axis A before the medium M encounters the sealing element 40.

With respect to the longitudinal axis A, said groove 50 is arranged radially on the inside of the sleeve 30 and the housing 20. The groove 50 is annular in shape. The groove 50 desirably defines several groove walls 50.1, 50.2, 50.3. At least one of the groove walls 50.1, 50.2, 50.3 is part of the proximal sleeve end 30.2. At least one of the groove walls 50.1, 50.2, 50.3 is part of the distal housing end 20.1.

In the embodiment of the pressure sensor 1 according to FIG. 1, the groove 50 is rectangular in cross-section and comprises three groove walls 50.1, 50.2, 50.3. Of the three groove walls 50.1, 50.2, 50.3, a first groove wall 50.1 and a second groove wall 50.2 are part of the proximal sleeve end 30.2 and a third groove wall 50.3 is part of the distal housing end 20.1. The first groove wall 50.1 and the third groove wall 50.3 are straight and arranged at an angle of 90° with respect to the longitudinal axis A, the second groove wall 50.2 is straight and arranged parallel to the longitudinal axis A.

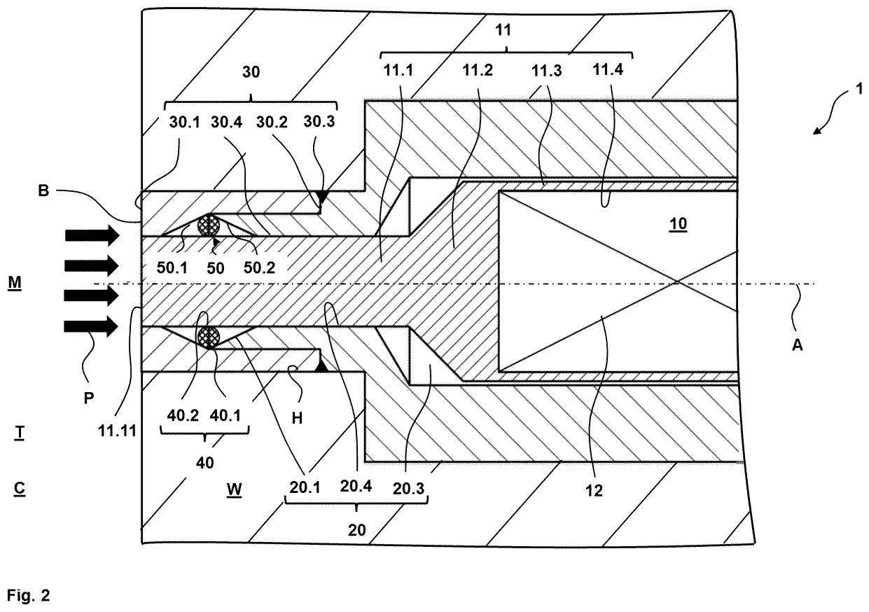

In the embodiment of the pressure sensor 1 according to FIG. 2, said groove 50 is triangular in cross-section and comprises two groove walls 50.1, 50.2. Of the two groove walls 50.1, 50.2, a first groove wall 50.1 is part of the proximal sleeve end 30.2 and a second groove wall 50.2 is part of the distal housing end 20.1. The first groove wall 50.1 and the second groove wall 50.2 are arranged in an inclined manner with respect to the longitudinal axis A. Preferably, the first groove wall 50.1 and the second groove wall 50.2 are arranged at an angle of 30° to the longitudinal axis A. The two inclined groove walls 50.1, 50.2 permit precise positioning of the sealing element 40 in the groove 50.

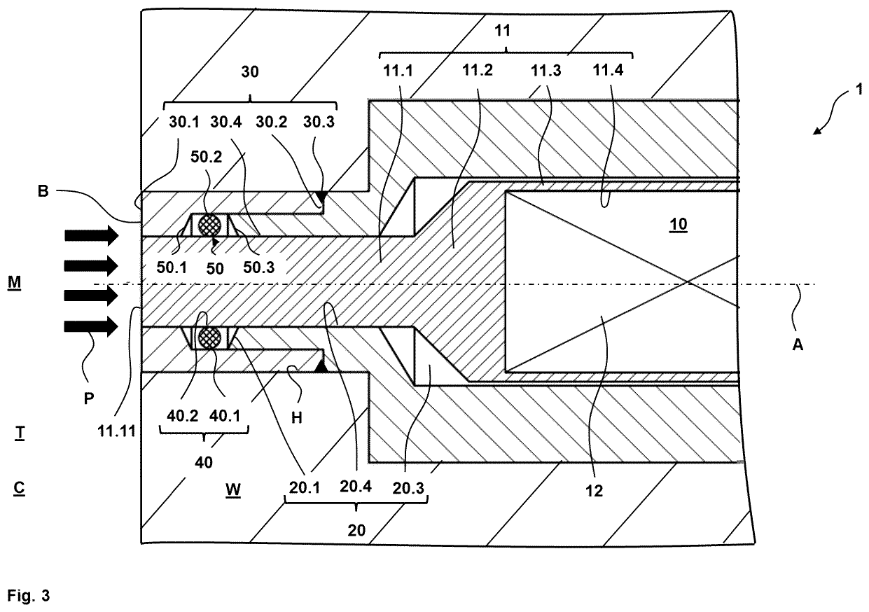

In the embodiment of the pressure sensor 1 according to FIG. 3, the groove 50 is trapezoidal in cross-section and comprises three groove walls 50.1, 50.2, 50.3. Of the three groove walls 50.1, 50.2, 50.3, a first groove wall 50.1 and a second groove wall 50.2 are part of the proximal sleeve end 30.2 and a third groove wall 50.3 is part of the distal housing end 20.1. The first groove wall 50.1 and the third groove wall 50.3 are arranged in an inclined manner with respect to the longitudinal axis A, the second groove wall 50.2 is arranged straight and parallel to the longitudinal axis A. Preferably, the first groove wall 50.1 and the third groove wall 50.3 are arranged at an angle of 30° to the longitudinal axis A.

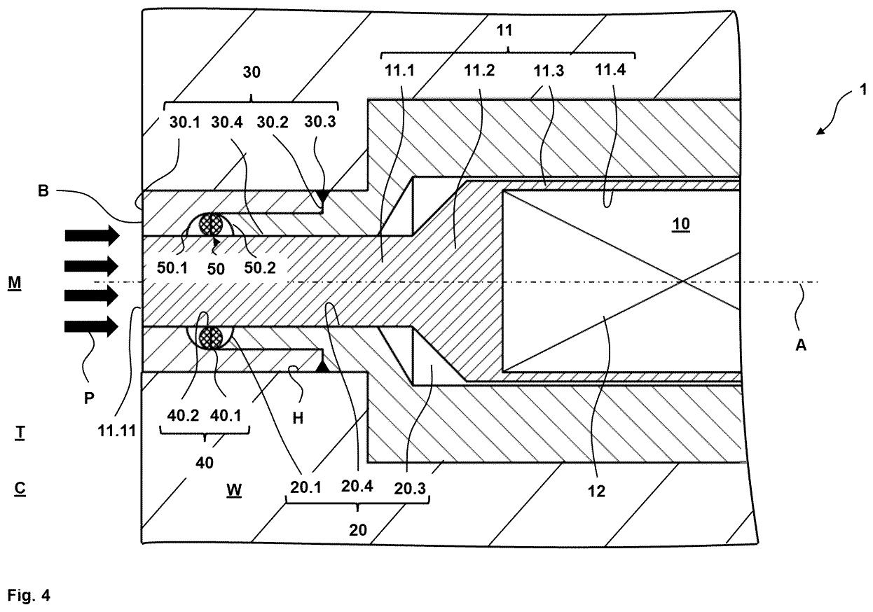

In the embodiment of the pressure sensor 1 according to FIG. 4, the groove is round in cross-section and comprises two groove walls 50.1, 50.2. Of the two groove walls 50.1, 50.2, a first groove wall 50.1 is part of the proximal sleeve end 30.2 and a second groove wall 50.2 is part of the distal housing end 20.1. The first groove wall 50.1 is round and curved from the longitudinal axis A into the proximal sleeve end 30.2. Preferably, the curvature exhibits a constant radius. The second groove wall 50.2 is round and curved from the longitudinal axis A into the distal housing end 20.1. Preferably, the curvature exhibits a constant radius. The two round groove walls 50.1, 50.2 allow precise positioning of the sealing element 40 in the groove 50.

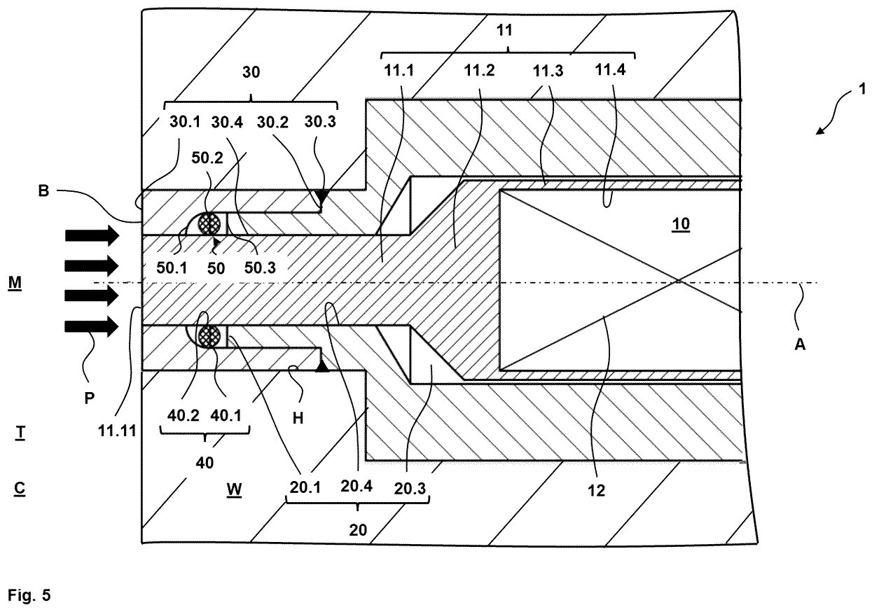

In the embodiment of said pressure sensor 1 according to FIG. 5, the groove is semicircular and comprises three groove walls 50.1, 50.2, 50.3. Of the three groove walls 50.1, 50.2, 50.3, a first groove wall 50.1 and a second groove wall 50.2 are part of the proximal sleeve end 30.2 and a third groove wall 50.3 is part of the distal housing end 20.1. The first groove wall 50.1 is round and curved from the longitudinal axis A into the proximal sleeve end 30.2. Preferably, the curvature exhibits a constant radius. The second groove wall 50.2 is straight and arranged parallel to the longitudinal axis A. The third groove wall 50.3 is straight and arranged at an angle of 90° with respect to the longitudinal axis A.

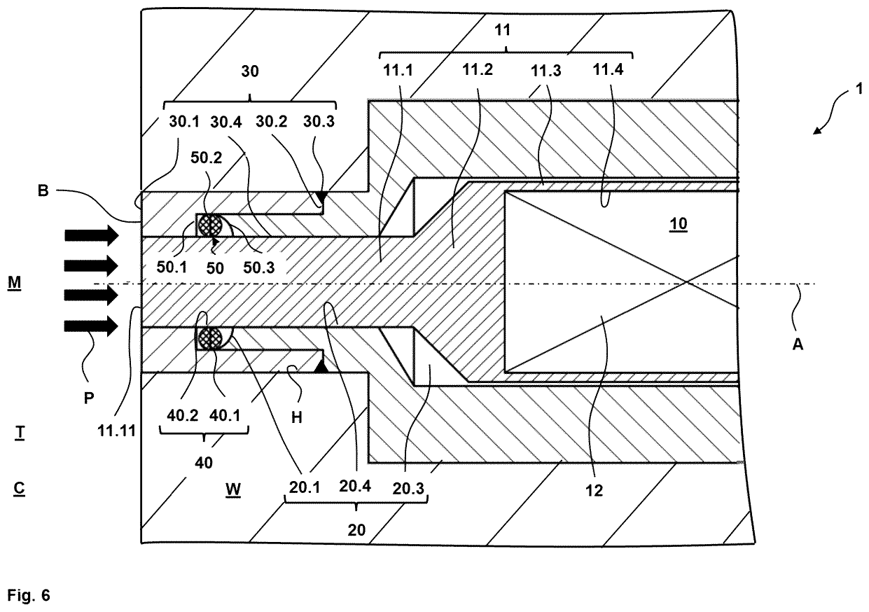

In the embodiment of said pressure sensor 1 according to FIG. 6, the groove is semicircular and comprises three groove walls 50.1, 50.2, 50.3. Of the three groove walls 50.1, 50.2, 50.3, a first groove wall 50.1 and a second groove wall 50.2 are part of the proximal sleeve end 30.2 and a third groove wall 50.3 is part of the distal housing end 20.1. The first groove wall 50.1 is straight and is arranged at an angle of 90° with respect to the longitudinal axis A. The second groove wall 50.2 is straight and arranged parallel to the longitudinal axis A. The third groove wall 50.3 is round and curved from the longitudinal axis A into the distal housing end 20.1. Preferably, the curvature exhibits a constant radius.

With the knowledge of the present invention, the skilled artisan can also combine the six embodiments of the groove 50 shown in FIGS. 1 to 6.

According to the invention, the pressure sensor 1 comprises at least one sealing element 40. The sealing element 40 is configured to perform the function of sealing the gap 30.4. In the sense of the invention, the verb “seal” has the meaning that no medium M can enter the housing interior 20.3 through the gap 30.4 during operation of the pressure sensor 1. Preferably, the sealing element 40 permanently seals the gap 30.4 at a temperature in the range from 100° C. to 500° C. and at a pressure P in the range from 50 bar to 5000 bar. The sealing element 40 is toroidal in shape and consists of elastically sealing material such as elastomer, in particular fluoroelastomer or perfluoroelastomer, rubber, in particular acrylonitrile-butadiene rubber, etc.

In the embodiments schematically shown in the figures, the sealing element 40 is defined by a toroidal sealing body 40.1, which defines a torus opening 40.2. The toroidal sealing body 40.1 encloses the torus opening 40.2. The distal plunger end 11.1 protrudes through the torus opening 40.2.

The sealing element 40 is arranged in the groove 50. The sealing element 40 seals the gap 30.4 by means of sealing pressure. The sealing pressure can be applied as axial sealing pressure along the longitudinal axis A, or as radial sealing pressure perpendicular to the longitudinal axis A, or as a combination of axial sealing pressure along the longitudinal axis A and radial sealing pressure perpendicular to the longitudinal axis A. The sealing element 40 is arranged with a pre-compression in the groove 50. The pre-compression is exerted on the sealing element 40 by said groove walls 50.1, 50.2, 50.3. In addition to the pre-compression, the pressure P in the gap 30.4 acts as a compression on the sealing element 40. The sealing pressure is thus formed by the pre-compression and the compression.

With the knowledge of the present invention, the person skilled in the art can also arrange several sealing elements in one groove or in several grooves. With respect to the longitudinal axis A, the plurality of sealing elements are then arranged successively and then seal the gap 30.4 several times.

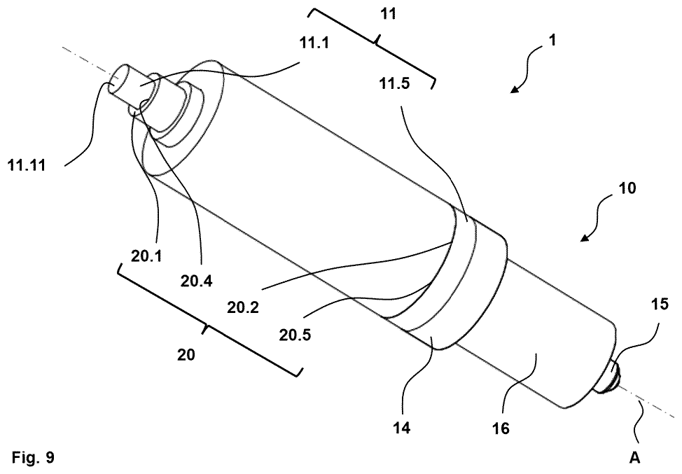

With reference to the disassembled view of FIG. 8, FIGS. 9 to 11 show views of three successive steps of the method according to the invention for manufacturing the pressure sensor 1. The views of FIGS. 9 to 11 also show the pressure sensor 1 along a longitudinal axis A of the pressure sensor 1.

In a first step of the method according to the present invention as shown in FIG. 9, a housing 20 and a sensor unit 10 are provided and the housing 20 is pushed so as to move with respect to the plunger unit 11 along the longitudinal axis A over the plunger unit 11 and placed on the sensor unit 10. As a result, the plunger unit 11 enters the housing interior 20.3. The distal plunger end 11.1 thus protrudes through the housing opening 20.4. The proximal housing end 20.2 sits on the pre-load body 11.5. The housing 20 placed on the pre-load body 11.5 in this way is fastened to the pre-load body 11.5 via a housing pre-load body connection 20.5. With respect to the longitudinal axis A, the housing pre-load body connection 20.5 is arranged radially on the outside of the housing 20 and the pre-load body 11.5. The housing pre-load body connection 20.5 is made by welding, soldering, screwing, etc. In the embodiments shown in the figures, the housing pre-load body connection 20.5 is a welded connection.

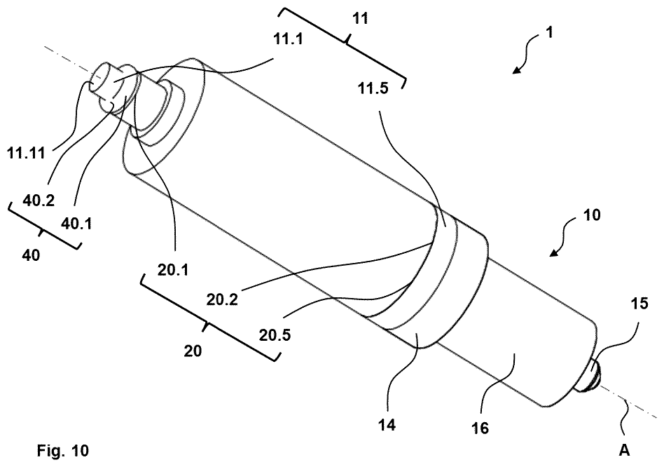

In a second step of the method according to the present invention as shown in FIG. 10, a sealing element 40 is provided and pushed so as to move with respect to the plunger unit 11 along the longitudinal axis A over the distal plunger end 11.1 and placed on the housing 20. The distal plunger end 11.1 thereby protrudes through the torus opening 40.2.

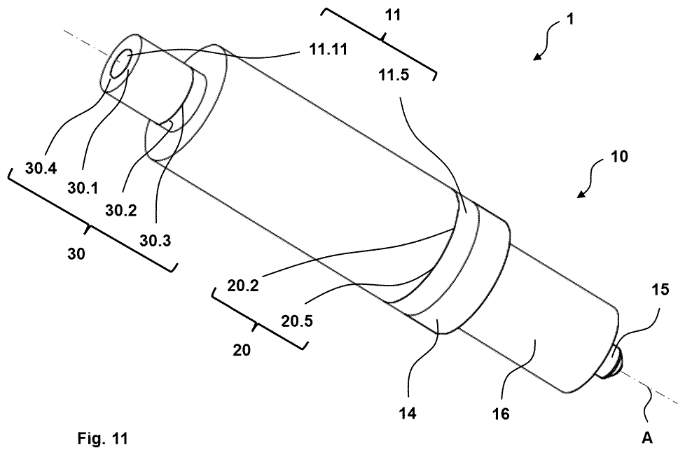

In a third step of the method according to the present invention as shown in FIG. 11, a sleeve 30 is provided and pushed so as to move with respect to the plunger unit 11 along the longitudinal axis A over the distal plunger end 11.1 and placed on the sealing element 40 and the housing 20. The proximal sleeve end 30.2 rests on the distal housing end 20.1. The sleeve 30 placed on the housing 20 in this way is attached to the housing 20 via the sleeve-housing connection 30.3. The sealing element 40 is pre-pressed through the superimposed sleeve 30 and the housing 20.

### LIST OF REFERENCE NUMERALS

1 Pressure sensor
11 Plunger unit
11.1 Distal plunger end
11.11 Pressure absorption surface
11.2 Proximal plunger end
11.3 Pre-load sleeve
11.4 Pre-load sleeve chamber
11.5 Pre-load body
12 Measuring element
14 Socket unit
10 Sensor unit
13 Electrode arrangement
15 Socket contact
16 Insulation body
20 Housing
20.1 Distal housing end
20.2 Proximal housing end
20.3 Housing interior
20.4 Housing opening
20.5 Housing pre-load body connection
30 Sleeve
30.1 Distal sleeve end
30.2 Proximal sleeve end
30.3 Sleeve-housing connection
30.4 Gap
40 Sealing element
40.1 toroidal sealing body
40.2 Torus opening
50 Groove
50.1 First groove wall
50.2 Second groove wall
50.3 Third groove wall
A Longitudinal axis
B Pressure absorption level
C Pressure chamber
H Bore
M Medium
P Pressure
S Measuring signal
T Temperature
W Wall

What is claimed is:

1. Pressure sensor for detecting the pressure of a medium, the pressure sensor elongating along a longitudinal axis and comprising:
a housing that defines a housing interior;
a measuring element disposed in the housing interior;
a plunger unit disposed in the housing interior and including a proximal plunger end and a distal plunger end spaced apart along the longitudinal axis from the proximal plunger end, wherein the proximal plunger end has a disposition near the measuring element, wherein the proximal plunger end is configured to transmit from the measuring element a signal indicative of a pressure of a medium prevailing outside the housing and detected by the measuring element, wherein the distal plunger end protrudes from the housing and is disposed farther from the measuring element than the disposition of the proximal plunger end;
a sleeve fastened to the housing and spaced apart from the distal plunger end by a gap; and
a sealing element configured and disposed to apply a sealing pressure sufficient to seal the gap to prevent passage of the medium into the housing interior.

2. Pressure sensor according to claim 1, wherein the sealing element is toroidal in shape and consists of elastically sealing material.

3. Pressure sensor according to claim 2, wherein the sealing element defines a toroidal sealing body that defines a torus opening;
wherein the distal plunger end protrudes through the torus opening.

4. Pressure sensor according to claim 1, wherein the sleeve and the housing form a groove on a radially inner side of the sleeve with respect to the longitudinal axis; and wherein the sealing element is disposed in the groove.

5. Pressure sensor according to claim 4, wherein the groove comprises a plurality of groove walls that exert a pre-compression on the sealing element disposed in the groove; and wherein the pressure in the gap acts on the sealing element as a compression in addition to the pre-compression, which pre-compression and which compression form the sealing pressure.

6. Pressure sensor according to claim 4, wherein the housing-defines a distal housing end and a proximal housing end, which distal housing end is arranged along the longitudinal axis further away from the measuring element than the proximal housing end;
wherein the sleeve defines a distal sleeve end and a proximal sleeve end, which distal sleeve end is arranged along the longitudinal axis further away from the measuring element than the proximal sleeve end; and
wherein the groove is arranged in the region of the distal housing end and the proximal sleeve end.

7. Pressure sensor according to claim 6, wherein the groove-includes a groove wall defined in the proximal sleeve end and a groove wall defined in the distal housing end.

8. Pressure sensor according to claim 7, the shape of the groove in a cross section cut along the longitudinal axis is rectangular or triangular or trapezoidal or round or semicircular.

9. Pressure sensor according to claim 1, wherein the plunger unit includes a pre-load sleeve and a pre-load body; wherein the proximal plunger end merges into the pre-load sleeve; wherein the pre-load sleeve encloses a pre-load sleeve chamber, in which pre-load sleeve chamber the measuring element is arranged; wherein an end of the pre-load sleeve facing away from the proximal plunger end is fastened to the pre-load body; and wherein the measuring element is arranged on the longitudinal axis between the proximal plunger end and the pre-load body under a mechanical pre-load.

10. Pressure sensor according to claim 1, wherein the housing is configured to be fastened in a bore of a wall of a pressure chamber in which the pressure of the medium is in the range from 50 bar to 5000 bar.

11. Method for manufacturing a pressure sensor that includes a housing, a plunger unit and a sensing unit that includes a measuring element; which housing defines a housing interior and which plunger unit and which measuring element are arranged in the housing interior; which plunger unit defines a distal plunger end and a proximal plunger end, which distal plunger end is arranged on a longitudinal axis of the pressure sensor further away from the measuring element than the proximal plunger end and which distal plunger end protrudes from the housing and which proximal plunger end is in operative connection with the measuring element and configured to transmit to the measuring element, a signal indicative of a pressure of a medium prevailing outside the housing; the method comprising the following steps:
moving the housing along the longitudinal axis over the plunger unit and then placing the housing on the sensor unit;
moving a sealing element along the longitudinal axis over the distal plunger end and then placing the sealing element on the housing; and
moving a sleeve along the longitudinal axis over the distal plunger end and then placing the sleeve on the sealing element and the housing so that the sleeve is spaced apart from the distal plunger end by a gap that is sealed sufficiently by the sealing element with a sealing pressure that prevents the medium from entering the housing interior.

12. Method according to claim 11, wherein the distal plunger end includes a pre-load body and the housing is fastened to the pre-load body via a housing pre-load body connection; which housing pre-load body connection is arranged radially on the outside of the housing and on the pre-load body with respect to the longitudinal axis.

13. Method according to claim 11, wherein a groove is formed radially on the inside of the sleeve and the housing with respect to the longitudinal axis by placing the sleeve on the housing around the sealing element.

14. Method according to claim 11, further comprising the step of pre-stressing said sealing element between the sleeve and the housing.

15. Method according to claim 11, wherein the sleeve placed on the housing is fastened to the housing via a sleeve-housing connection, which sleeve-housing connection is arranged radially on the outside of the sleeve and on the housing with respect to the longitudinal axis.

16. The pressure sensor according to claim 2, wherein the elastically sealing material of the sealing element is a fluoroelastomer, a perfluoroelastomer, a rubber or an acrylonitrile-butadiene rubber.
